(19) United States
(12) Patent Application Publication
(10) Pub. No.: US 2018/0355724 A1
(43) Pub. Date: Dec. 13, 2018

(54) A RADIAL TURBINE IMPELLER AND A METHOD FOR MANUFACTURING THE SAME

(71) Applicant: Lappeenrannan teknillinen yliopisto, Lappeenranta (FI)

(72) Inventors: Samuli NIKKANEN, Lappeenranta (FI); Eero SCHERMAN, Lappeenranta (FI); Janne NERG, Lappeenranta (FI)

(21) Appl. No.: 15/780,959

(22) PCT Filed: Nov. 29, 2016
(86) PCT No.: PCT/FI2016/050837

§ 371 Date: Jun. 1, 2018

(30) Foreign Application Priority Data
Dec. 1, 2015 (FI) 20155903

(51) Int. Cl. F01D 5/04; F01D 1/06; F01D 5/30

(52) U.S. Cl. CPC F01D 5/041; F01D 1/06; F05D 2240/30; F05D 2230/60; F01D 5/30

(57) ABSTRACT

A radial turbine impeller includes a turbine wheel module including a first surface and a second surface being mutually opposite in the axial direction of the radial turbine impeller. The radial turbine impeller includes blade modules attached to the turbine wheel module. Each blade module is a single piece of material and includes a body portion and blades connected to the body portion and protruding in the axial direction from the body portion. At least the first surface of the turbine wheel module is provided with one or more annular grooves opening in the axial direction and containing the body portions of the blade modules so that, in each of the grooves, the blade modules are successively in the circumferential direction. The radial turbine impeller further includes a securing system for keeping the body portions of the blade modules in the one or more grooves.

### FIELD OF THE DISCLOSURE

The disclosure relates generally to mechanical constructions of turbine impellers. More particularly, the disclosure relates to a mechanical construction of a radial turbine impeller. Furthermore, the disclosure relates to a method for manufacturing a radial turbine impeller.

### BACKGROUND

In many cases, a turbine impeller of especially small turbine devices is manufactured from one solid piece of base metal that can be for example titanium. A turbine device of the kind mentioned above can be, for example but not necessarily, a part of an integrated turbine-generator of a waste heat recovery system or a compact size energy conversion system. The above-described method of manufacture is however quite expensive and requires sophisticated computer controlled machining. Furthermore, the risk of failure in the manufacturing process is remarkable because a manufacturing defect in a single place of the turbine impeller, e.g. in one blade, causes that the whole turbine impeller is deemed to be defective. Furthermore, in a case of a blade failure, the whole turbine impeller has to be changed. Another method of manufacture is mold casting but mold casting has its own challenges, e.g. a turbine impeller manufactured by mold casting can be mechanically weaker than a turbine impeller manufactured by machining. Furthermore, a cast billet of a turbine impeller may require final machining. Turbine impellers of many large turbine devices, such as e.g. gas turbines, are typically constructed so that separate blades are attached to a hub section. In this case, the each blade and the hub section can be manufactured separately and thus the risk of failure in the manufacturing process is remarkably smaller than in the above-mentioned case where a turbine impeller is machined from one solid piece of base metal.

The technology in which separate blades are attached to a hub section is however not free from challenges. One of the challenges is related to a need for reliable securing system for keeping the blades attached to the hub section also in demanding operating conditions. Especially in conjunction with turbine impellers of small turbine devices, the physical dimensions of the joints between the blades and the hub section can be small and thereby it may be difficult to arrange a reliable securing system for keeping the blades attached to the hub section.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

In accordance with the invention, there is provided a new radial turbine impeller. A radial turbine impeller according to the invention comprises:
a turbine wheel module comprising a first surface and a second surface that are mutually opposite in the axial direction of the radial turbine impeller, and
blade modules attached to the turbine wheel module, each blade module being a single piece of material and comprising a body portion and one or more blades connected to the body portion and protruding in the axial direction from the body portion, and at least one of the blade modules comprising at least two blades.

At least the first surface of the turbine wheel module is provided with one or more annular grooves opening in the axial direction and containing the body portions of the blade modules so that, in each of the grooves, the blade modules are successively in the circumferential direction.

The radial turbine impeller further comprises a securing system for keeping the body portions of the blade modules in the one or more annular grooves.

As the body portions of the blade modules are in the annular grooves which open in the axial direction, the centrifugal force does not stress the above-mentioned securing system in the same way as e.g. in cases where radial blades are attached to the outer periphery of a hub section. Furthermore, the securing system is more straightforward to construct than in a case where every blade is separately attached to a hub-section because each of the above-mentioned blade modules whose size is relevant from the viewpoint of the securing system comprises advantageously many blades. The turbine wheel module and the blade modules can be manufactured of different materials. In many cases, the above-described radial turbine impeller is cheaper to manufacture than a corresponding radial turbine impeller machined from a single piece of material. Furthermore, in a case of a blade failure, only the broken blade module needs to be replaced.

In accordance with the invention, there is provided also a new a method for manufacturing a radial turbine impeller. A method according to the invention comprises:
manufacturing a turbine wheel module comprising a first surface and a second surface that are mutually opposite in the axial direction of the radial turbine impeller,
manufacturing blade modules, each blade module being a single piece of material and comprising a body portion and one or more blades connected to the body portion and protruding in the axial direction from the body portion, and at least one of the blade modules comprising at least two blades,
making, on at least the first surface of the turbine wheel module, one or more annular grooves opening in the axial direction,
placing the body portions of the blade modules into the one or more grooves so that, in each of the grooves, the blade modules are successively in the circumferential direction, and
attaching the blade modules to the turbine wheel module with a securing system for keeping the body portions of the blade modules in the one or more grooves.

A number of exemplifying and non-limiting embodiments of the invention are described in accompanied dependent claims.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF THE FIGURES

Exemplifying and non-limiting embodiments of the invention and their advantages are explained in greater detail below in the sense of examples and with reference to the accompanying drawings, in which:

FIG. 1a shows a radial turbine impeller according to an exemplifying and non-limiting embodiment of the invention,

FIG. 1b shows a section view of a turbine wheel module of the radial turbine impeller shown in FIG. 1a,

FIG. 1c shows a blade module of the radial turbine impeller shown in FIG. 1a,

FIG. 1d shows the radial turbine impeller shown in FIG. 1a during an assembly phase,

FIGS. 2a, 2b and 2c illustrate details of the radial turbine impeller shown in FIG. 1a, and

FIG. 3 shows a flowchart of a method according to an exemplifying and non-limiting embodiment of the invention for manufacturing a radial turbine impeller.

### DESCRIPTION OF EXEMPLIFYING AND NON-LIMITING EMBODIMENTS

The specific examples provided in the description given below should not be construed as limiting the scope and/or the applicability of the appended claims. Lists and groups of examples provided in the description given below are not exhaustive unless otherwise explicitly stated.

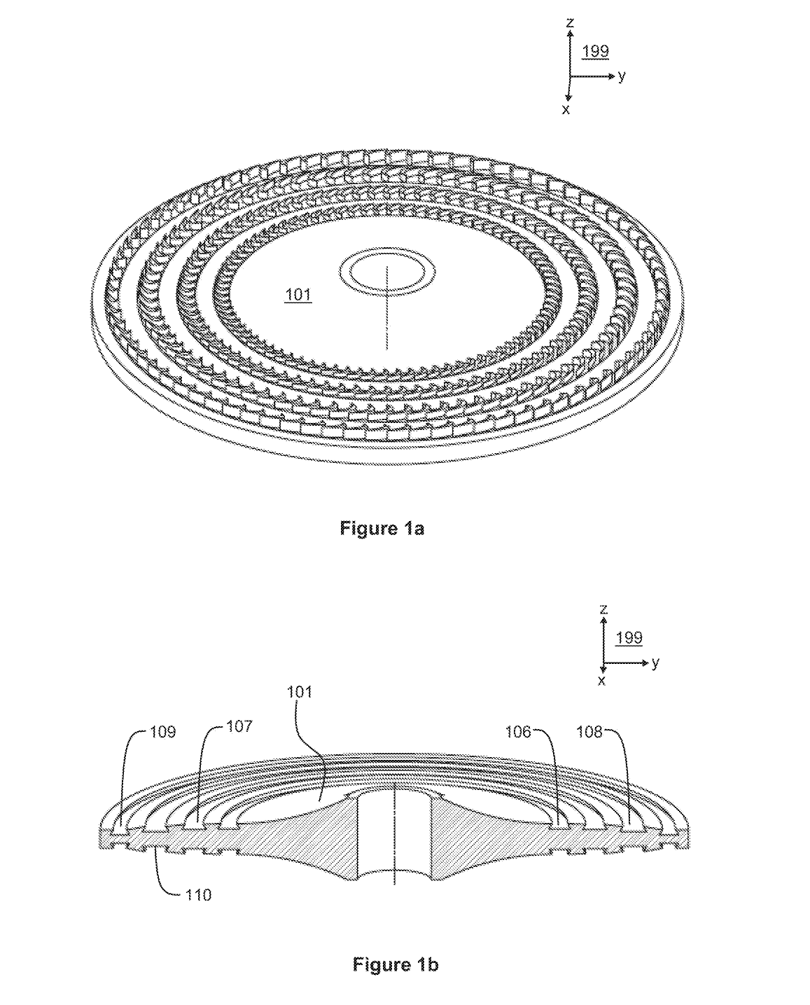

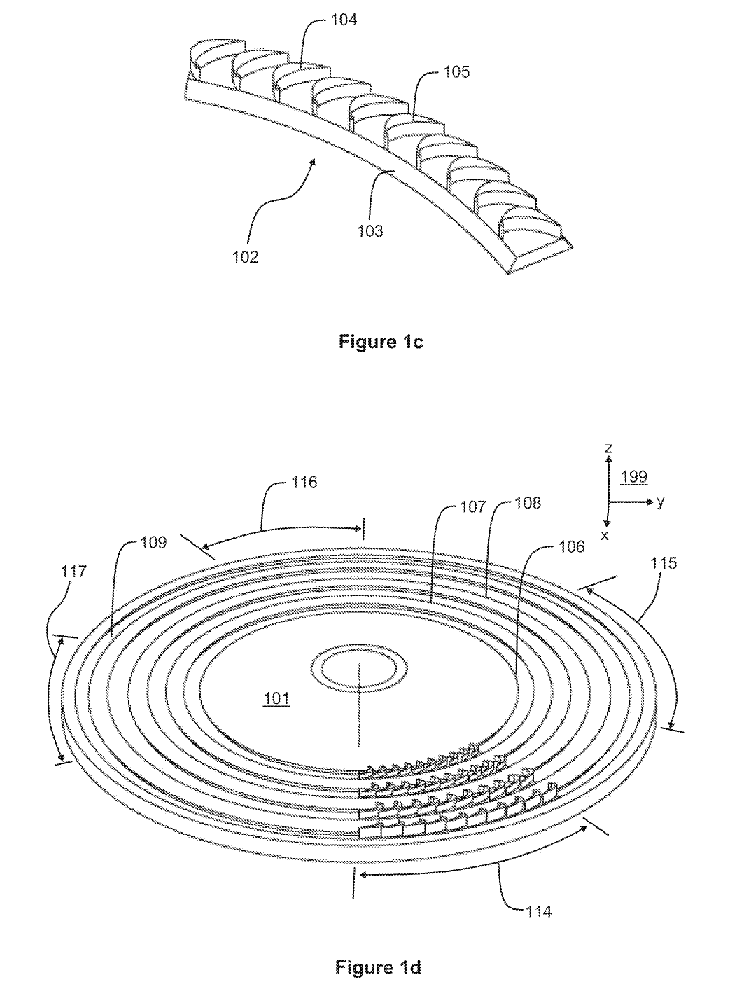

FIG. 1a shows a radial turbine impeller according to an exemplifying and non-limiting embodiment of the invention. The radial turbine impeller comprises a turbine wheel module 101 comprising a first surface and a second surface that are mutually opposite in the axial direction of the radial turbine impeller. The axial direction is parallel with the z-axis of a coordinate system 199. A section view of the turbine wheel module 101 is shown in FIG. 1b. The section plane is parallel with the yz-plane of the coordinate system 199. The radial turbine impeller comprises blade modules attached to the turbine wheel module 101. One of the blade modules is a blade module 102 that is shown in FIG. 1c. Each blade module is a single piece of material and comprises a body portion and blades connected to the body portion and protruding in the axial direction from the body portion. In FIG. 1c, the body portion of the blade module 102 is denoted with a figure reference 103 and two of the blades of the blade module 102 are denoted with figure references 104 and 105. Each blade module can be manufactured separately from the turbine wheel module 101 and from other blade modules using for example mold casting, and/or computer controlled machining, and/or some other suitable methods. Since the blade modules can be manufactured as separate pieces, the manufacturing process can be straightforward, the blade modules can be easily surface coated, and different materials can be easily tested.

The above-mentioned first and second surfaces of the turbine wheel module 101 are provided with annular grooves opening in the axial direction. In FIG. 1b, the annular grooves on the first surface are denoted with figure references 106, 107, 108, and 109. In FIG. 1b, one of the annular grooves on the second surface is denoted with a figure reference 110. FIG. 1d shows the radial turbine impeller shown in FIG. 1a during an assembly phase where four of the blade modules have been installed on the turbine wheel module 101. As can be understood with the aid of FIGS. 1a-1d, the annular grooves contain the body portions of the blade modules so that, in each of the grooves, the blade modules are successively in the circumferential direction of the radial turbine impeller.

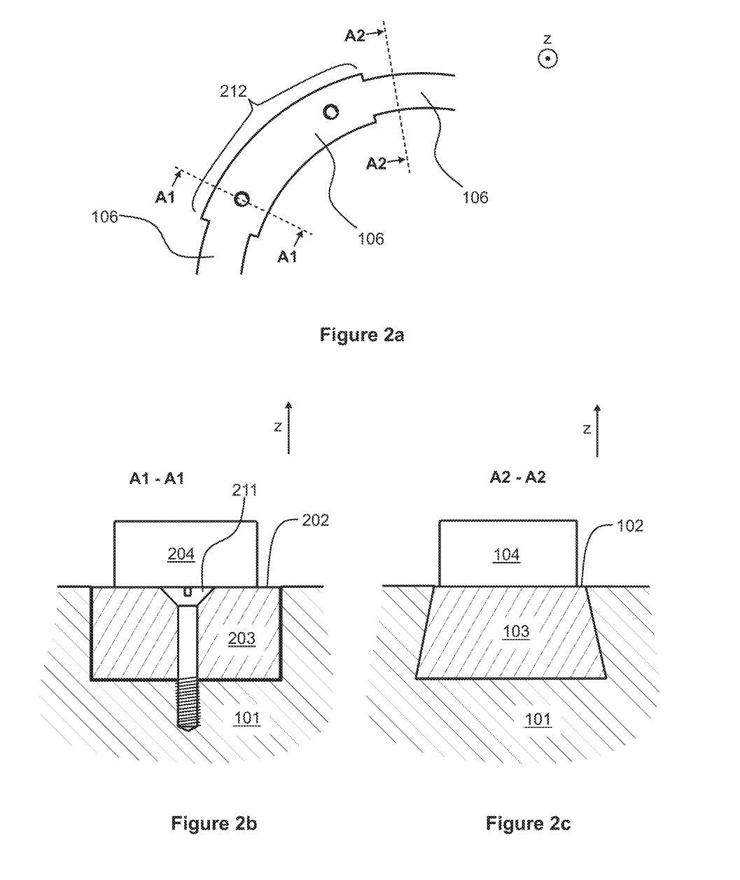

The radial turbine impeller illustrated in FIGS. 1a-1d further comprises a securing system for keeping the body portions of the blade modules in the annular grooves of the turbine wheel module 101. The securing system is explained below with reference to FIGS. 2a, 2b, and 2c. FIG. 2a shows a part of the annular groove 106 of the turbine wheel module 101 shown in FIGS. 1a, 1b, and 1d. Elements of the securing system related to the other ones of the annular grooves of the turbine wheel module 101 can be similar to the below-described elements of the securing system related to the annular groove 106. FIG. 2b shows a section taken along a line A1-A1 shown in FIG. 2a. The securing system comprises one or more fastening elements 211 for attaching, to the turbine wheel module 101, a first blade module 202 that is one of the blade modules whose body portions are in the annular groove 106. It is to be noted that the blade module 202 is not shown in FIG. 2a. The annular groove 106 comprises a segment 212 for containing the body portion 203 of the blade module 202. In FIG. 2b, one of the blades of the blade module 202 is denoted with a figure reference 204. In the exemplifying case illustrated in FIGS. 2a and 2b, the fastening elements 211 are screws and one of the screws is shown in FIG. 2b. The securing system comprises axial shape locking between the annular groove 106 and second ones of the blade modules whose body portions are in the annular groove 106. One of the second ones of the blade modules is the blade module 102 shown in FIG. 1c. FIG. 2c shows a section taken along a line A2-A2 shown in FIG. 2a. It is to be noted that the blade module 102 is not shown in FIG. 2a. As can be seen from FIG. 2c, the above-mentioned axial shape locking means that the cross-sectional shape of the annular groove 106 and the cross-sectional shape of the body portions of the second ones of the blade modules are arranged to prevent the body portions of the second ones of the blade modules from leaving the annular groove 106 in the axial direction, i.e. in the z-direction shown in FIGS. 2a-2c. In the exemplifying case illustrated in FIG. 2c, the axial shape locking in implemented with a dove tail joint. It is, however, also possible to use other shapes for achieving the axial shape locking.

The above-mentioned segment 212 of the annular groove 106 allows the body portions of the second ones of the blade modules, such as the blade module 102, to be inserted in the annular groove 106 and subsequently to be slid circumferentially along the annular groove 106. The blade modules located in different ones of the annular grooves and attached with the fastening elements, such as the blade module 202, are advantageously placed in different sectors in the circumferential direction so as to facilitate the balancing of the radial turbine impeller. For example, the segment 212 of the groove 106 can be on a sector 114 shown in FIG. 1d, the corresponding segment of the groove 107 can be on a sector 115, the corresponding segment of the groove 108 can be on a sector 116, and the corresponding segment of the groove 109 can be on a sector 117 shown in FIG. 1d. The above-mentioned segments which allow the insertion of the blade modules are not depicted in FIGS. 1b and 1d.

It is worth noting that the above-described securing system for keeping the body portions of the blade modules in the annular grooves of the turbine wheel module is not the only possible choice. For example, it is also possible that all the blade modules are attached to the turbine wheel module with fastening elements such as e.g. screws.

Furthermore, it is worth noting that a radial turbine impeller according to an exemplifying and non-limiting embodiment of the invention may comprise blade modules which have different number of blades. For example, one or more of the blade modules which are attached with shape locking of the kind illustrated in FIG. 2c may comprise only one blade whereas a blade module which is attached with an arrangement of the kind illustrated in FIG. 2b may comprise many blades.

In a radial turbine impeller according to an exemplifying and non-limiting embodiment of the invention, the materials of the turbine wheel module 101 and blade modules are selected in such a way the thermal expansion will have a tightening effect. This can be achieved by selecting the materials so that the thermal expansion coefficient of the material of the turbine wheel module 101 is smaller than the thermal expansion coefficient of the material of the blade modules.

The material pairs for the turbine wheel module 101 and for the blade modules can be for example but not necessarily:
titanium for the turbine wheel module and steel, e.g. stainless steel, for the blade modules,
titanium for the turbine wheel module and aluminum for the blade modules,
titanium for the turbine wheel module and magnesium for the blade modules,
steel, e.g. stainless steel, for the turbine wheel module and aluminum for the blade modules,
steel, e.g. stainless steel, for the turbine wheel module and magnesium for the blade modules.

The thermal expansion coefficient for length for titanium is about 8.5×10⁻⁶/K. The thermal expansion coefficient for length for steel, e.g. stainless steel, is about 11-18×10⁻⁶/K. The thermal expansion coefficient for length for aluminum is about 24×10⁻⁶/K. The thermal expansion coefficient for length for magnesium is about 26×10⁻⁶/K.

In the exemplifying radial turbine impeller illustrated in FIGS. 1a-1d, there are blades on both sides of the turbine wheel module 101. In a radial turbine impeller according to another exemplifying and non-limiting embodiment of the invention, there are blades on only one side of the turbine wheel module. The exemplifying radial turbine impeller illustrated in FIGS. 1a-1d has four turbine stages. As can be easily understood on the basis of FIGS. 1a-1d, the number of the turbine stages is not necessarily four but can be more than four or less than four. Furthermore, a same turbine wheel module can be used for turbines for different pressure levels because the blade height can be selected by using suitable blade modules.

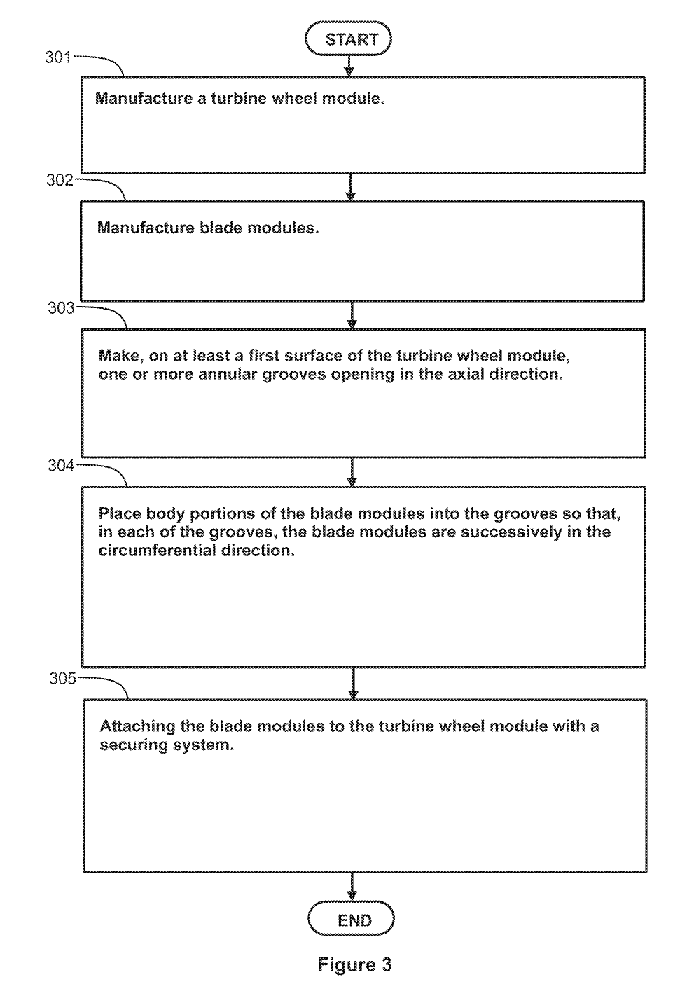

FIG. 3 shows a flowchart of a method according to an exemplifying and non-limiting embodiment of the invention for manufacturing a radial turbine impeller. The method comprises the following actions:
action 301: manufacturing a turbine wheel module comprising a first surface and a second surface that are mutually opposite in the axial direction of the radial turbine impeller,
action 302: manufacturing blade modules, each blade module being a single piece of material and comprising a body portion and one or more blades connected to the body portion and protruding in the axial direction from the body portion, and at least one of the blade modules comprising at least two blades,
action 303: making, on at least the first surface of the turbine wheel module, one or more annular grooves opening in the axial direction,
action 304: placing the body portions of the blade modules into the one or more grooves so that, in each of the grooves, the blade modules are successively in the circumferential direction, and
action 305: attaching the blade modules to the turbine wheel module with a securing system for keeping the body portions of the blade modules in the one or more grooves.

In a method according to an exemplifying and non-limiting embodiment of the invention, each of the blade modules comprises at least two blades.

In a method according to an exemplifying and non-limiting embodiment of the invention, each of the blade modules comprises at least five blades.

The manufacturing 301 of the turbine wheel module may comprise for example machining the turbine wheel module from a piece of metal that can be for example titanium. It is also possible that the manufacturing of the turbine wheel module comprises mold casting and machining the cast billet of the turbine wheel module.

The manufacturing 302 of the blade modules may comprise for example machining each blade module from a piece of metal. It is also possible that the manufacturing of a blade module comprises mold casting the blade module and machining the cast billet of the blade module, or mold casting only. It is also possible that the manufacturing of a blade module comprises three-dimensional “3D” printing the blade module, and possibly fine machining the 3D-printed blade module. An advantage of the 3D-printing is the capability to make e.g. hollow structures and structures which comprise cooling channels. Furthermore, the manufacturing of a blade module may comprise coating the surface of the blade module with suitable material, e.g. copper, which is resistant against e.g. corrosion and/or certain chemicals.

The specific examples provided in the description given above should not be construed as limiting the scope and/or the applicability of the appended claims. Lists and groups of examples provided in the description given above are not exhaustive unless otherwise explicitly stated.

1. A radial turbine impeller comprising:
a turbine wheel module comprising a first surface and a second surface being mutually opposite in an axial direction of the radial turbine impeller, and
blade modules attached to the turbine wheel module, each blade module being a single piece of material and comprising a body portion and one or more blades connected to the body portion and protruding in the axial direction from the body portion,
wherein at least one of the blade modules comprises at least two blades, and at least the first surface of the turbine wheel module is provided with one or more annular grooves opening in the axial direction and containing the body portions of the blade modules so that, in each of the annular grooves, the blade modules are successively in a circumferential direction, and the radial turbine impeller further comprises a securing system for keeping the body portions of the blade modules in the one or more annular grooves.

2. A radial turbine impeller according to claim 1, wherein each of the blade modules comprises at least two blades.

3. A radial turbine impeller according to claim 2, wherein each of the blade modules comprises at least five blades.

4. A radial turbine impeller according to claim 1, wherein the securing system comprises axial shape locking between at least one of the blade modules and at least one of the annular grooves so that the cross-sectional shape of the annular groove under consideration and the cross-sectional shape of the body portion of the blade module under consideration are arranged to prevent the body portion from leaving the annular groove in the axial direction.

5. A radial turbine impeller according to claim 4, wherein the cross-section of the annular groove under consideration and the cross-section the body portion of the blade module under consideration are shaped to constitute a dove tail joint between the annular groove under consideration and the body portion of the blade module under consideration.

6. A radial turbine impeller according to claim 1, wherein the securing system comprises one or more fastening elements attaching at least one of the blade modules to the turbine wheel module.

7. A radial turbine impeller according to claim 1, wherein the securing system comprises, for each of the one or more annular grooves:
one or more fastening elements attaching a first one of the blade modules whose body portions are in the annular groove under consideration to the turbine wheel module,
axial shape locking between the annular groove under consideration and second ones of the blade modules whose body portions are in the annular groove under consideration so that the cross-sectional shape of the annular groove under consideration and the cross-sectional shape of the body portions of the second ones of the blade modules are arranged to prevent the body portions of the second ones of the blade modules from leaving the annular groove in the axial direction, and
a segment of the annular groove under consideration so that the segment allows the body portions of the second ones of the blade modules to be inserted in the annular groove under consideration and subsequently to be slid circumferentially along the annular groove under consideration.

8. A radial turbine impeller according to claim 7, wherein the blade modules located in different ones of the annular grooves and attached with the fastening elements are placed, with respect to each other, in different sectors in the circumferential direction so as to facilitate the balancing of the radial turbine impeller.

9. A radial turbine impeller according to claim 1, wherein both the first and second surfaces of the turbine wheel module are provided with the annular grooves containing the body portions of the blade modules.

10. A radial turbine impeller according to claim 1, wherein a thermal expansion coefficient of material of the turbine wheel module is smaller than a thermal expansion coefficient of material of the blade modules.

11. A method for manufacturing a radial turbine impeller, the method comprising:
manufacturing a turbine wheel module comprising a first surface and a second surface being mutually opposite in an axial direction of the radial turbine impeller, and
manufacturing blade modules, each blade module being a single piece of material and comprising a body portion and one or more blades connected to the body portion and protruding in the axial direction from the body portion,
wherein at least one of the blade modules comprises at least two blades, and wherein the method further comprises:
making, on at least the first surface of the turbine wheel module, one or more annular grooves opening in the axial direction,
placing the body portions of the blade modules into the one or more annular grooves so that, in each of the annular grooves, the blade modules are successively in a circumferential direction, and
attaching the blade modules to the turbine wheel module with a securing system for keeping the body portions of the blade modules in the one or more annular grooves.

12. A method according to claim 11, wherein each of the blade modules comprises at least two blades.

13. A radial turbine impeller according to claim 2, wherein the securing system comprises axial shape locking between at least one of the blade modules and at least one of the annular grooves so that the cross-sectional shape of the annular groove under consideration and the cross-sectional shape of the body portion of the blade module under consideration are arranged to prevent the body portion from leaving the annular groove in the axial direction.

14. A radial turbine impeller according to claim 3, wherein the securing system comprises axial shape locking between at least one of the blade modules and at least one of the annular grooves so that the cross-sectional shape of the annular groove under consideration and the cross-sectional shape of the body portion of the blade module under consideration are arranged to prevent the body portion from leaving the annular groove in the axial direction.

15. A radial turbine impeller according to claim 2, wherein the securing system comprises one or more fastening elements attaching at least one of the blade modules to the turbine wheel module.

16. A radial turbine impeller according to claim 3, wherein the securing system comprises one or more fastening elements attaching at least one of the blade modules to the turbine wheel module.

17. A radial turbine impeller according to claim 4, wherein the securing system comprises one or more fastening elements attaching at least one of the blade modules to the turbine wheel module.

18. A radial turbine impeller according to claim 5, wherein the securing system comprises one or more fastening elements attaching at least one of the blade modules to the turbine wheel module.

19. A radial turbine impeller according to claim 2, wherein the securing system comprises, for each of the one or more annular grooves:
one or more fastening elements attaching a first one of the blade modules whose body portions are in the annular groove under consideration to the turbine wheel module,
axial shape locking between the annular groove under consideration and second ones of the blade modules whose body portions are in the annular groove under consideration so that the cross-sectional shape of the annular groove under consideration and the cross-sectional shape of the body portions of the second ones of the blade modules are arranged to prevent the body portions of the second ones of the blade modules from leaving the annular groove in the axial direction, and
a segment of the annular groove under consideration so that the segment allows the body portions of the second ones of the blade modules to be inserted in the annular groove under consideration and subsequently to be slid circumferentially along the annular groove under consideration.

20. A radial turbine impeller according to claim 3, wherein the securing system comprises, for each of the one or more annular grooves:
one or more fastening elements attaching a first one of the blade modules whose body portions are in the annular groove under consideration to the turbine wheel module,
axial shape locking between the annular groove under consideration and second ones of the blade modules whose body portions are in the annular groove under consideration so that the cross-sectional shape of the annular groove under consideration and the cross-sectional shape of the body portions of the second ones of the blade modules are arranged to prevent the body portions of the second ones of the blade modules from leaving the annular groove in the axial direction, and
a segment of the annular groove under consideration so that the segment allows the body portions of the second ones of the blade modules to be inserted in the annular groove under consideration and subsequently to be slid circumferentially along the annular groove under consideration.
